(19) United States
(12) Patent Application Publication
(10) Pub. No.: US 2008/0154604 A1
(43) Pub. Date: Jun. 26, 2008

(54) SYSTEM AND METHOD FOR PROVIDING CONTEXT-BASED DYNAMIC SPEECH GRAMMAR GENERATION FOR USE IN SEARCH APPLICATIONS

(75) Inventors: Sailesh Sathish, Tampere (FI); Dana Pavel, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/615,567

(22) Filed: Dec. 22, 2006

(51) Int. Cl. G10L 15/18

(52) U.S. Cl. 704/257

(57) ABSTRACT

A system and method for using a context-based dynamic speech recognition grammar generation system that is suitable for multimodal input when applied to context-based search scenarios. Dynamic context-based grammar is generated for a media stream during a post-processing period. The media stream is fed to an external automatic speech recognizer (ASR) for a specified number of frames. The ASR performs recognition of words that do not occur in common vocabulary that may be specific to those media frames. These words that are specific to the frames are sent back to the post processor, where they are fed to a dynamic grammar generator that generates speech grammars in some format, using the words that are fed to it. This grammar and other contextual information, form a new set of context data for those frames of media. The media, the grammar and other context data. is stored in a database. This is repeated for the entire stream of media, and a full speech recognition grammar can be constructed.

### FIELD OF THE INVENTION

The present invention relates generally to speech recognition systems. More particularly, the present invention relates to speech recognition grammar generation systems used to assist in the successful implementation of a speech recognition system.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A multimodal user interface enables users to interact with a system through the use of multiple simultaneous modalities such as speech, pen input, text input, gestures etc. For a speech+Graphical User Interface (GUI), a user can speak and input text at the same time. The output given by the system can occur through speech, audio and/or text. When deploying such systems, each modality (speech, GUI, etc.) is processed separately using respective modality processors. For example, speech recognition engines are used for speech, GUI modules for a graphical user interface, gesture recognition engines etc. The output from these engines are combined to provide meaningful input to the system.

Contextual interaction uses information from secondary sources (implicit modalities) to provide information to the system about the user's current context so that the system can perform adapted services that are suitable to the user's situation at the time. Examples of such sources include location information, calendar information, battery level, network signal strength, identification of current active application(s), active modalities, interaction history, etc. For speech recognition systems to work accurately, and particularly systems that are resident on a mobile device with limited capabilities, an accurate speech recognition “grammar” arrangement is needed that facilitates improved recognition.

There are several potential situations involving speech queries where user input can be open ended. In such situations, users may prefer to use open ended speech input combined with other modalities, as there uncertainties would exist in providing the exact search string. In such cases, it is up to the system to derive the relevant “tokens” from the input that would map to a proper query for searching the database. Once the information, which may comprise text and/or multimedia, is downloaded from the server, the user may wish to browse to certain locations or events of interest within the downloaded multimedia. This requires further fine-grained grammar parsing, as such precise searching can be intuitively performed on the client side rather than requiring a new search request be directed to the server. However, these types of open-ended searches conventionally would require speech recognizers with 10,000+ word grammar arrangements, which is not currently feasible due to the high computing power and memory that would be required.

### SUMMARY OF THE INVENTION

Various embodiments of the present invention involve the use of a context-based dynamic speech recognition grammar generation system that is suitable for multimodal input when applied to context-based search scenarios. According to various embodiments, dynamic context-based grammar is generated for an audio stream during a post-processing period. This is performed by a post processor along with an external automatic speech recognizer (ASR). The media stream is fed to the external ASR for a specified number of frames. The ASR performs recognition of words that do not occur in common vocabulary that may be specific to those media frames. These words that are specific to the frames are sent back to the post processor, where they are fed to a dynamic grammar generator that generates speech grammars in some format, for example, the speech recognition grammar format (SRGF), using the words that are fed to it. This grammar, along with other contextual information, forms a new set of context data for those frames of media. Additionally, the grammar may also contain information regarding the particular frame or frameset that to which a particular word is referred. The media, along with the grammar and other context data, is stored in a database. This is repeated for the entire stream of media, and a full speech recognition grammar can be constructed by appending all of the grammar generated for each segment of the media.

The various embodiments of the present invention, in addition to being useful for context-based search applications, may also be applicable to a variety of other applications as well. For example, the various embodiments of the present invention provides a platform for dynamic grammar generation wherever such applications are used.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a high-level framework within which various embodiments of the present invention may be implemented;

FIG. 2 is a flow chart depicting a process by which dynamic contextual grammar may be generated in accordance with various embodiments of the present invention;

FIG. 3 is a flow chart showing a user interaction process, once a speech grammar has been extracted through post processing, according to various embodiments of the present invention;

FIG. 4 is an overview diagram of a system within which the present invention may be implemented;

FIG. 5 is a perspective view of a mobile telephone that can be used in the implementation of the present invention; and

FIG. 6 is a schematic representation of the telephone circuitry of the mobile telephone of FIG. 5.

### DETAILED DESCRIPTION OF VARIOUS EMBODIMENTS

Various embodiments of the present invention involve the use of a context-based dynamic speech recognition grammar generation system that is suitable for multimodal input when applied to context-based search scenarios. These various embodiments involve the use of a number of components as discussed below.

A media post processing engine is capable of extracting “hot words” and building a finite state grammar (FSG) that is particular to a media item. As used herein, “hot words” refers to particular words that are distinguishable and belong to a certain class, such as a time, the name of a place, a person's name, an event name etc. The FSG contains subsets of classes and hot words belonging to those classes. The FSG may also have timing information and other media information that are associated with tokens. Therefore, particular tokens and token combinations can point to certain segments of a media item.

A network-based automatic speech recognizer (ASR) can be capable of accepting open ended queries and result in a string of words that the user uttered. A post processor or semantic interpreter, which may be positioned after the open-ended ASR, can match the uttered word string with a set of finite grammar classes. This can be used as a first iteration for searching. The group of identified FSG models can be combined with other data, e.g., metadata extractions from media, to perform searching for identifying the correct media. The media, along with its corresponding FSG, is downloaded to a client device, where a local ASR processes the media. The client device then uses the FSG for navigating and searching within the downloaded media.

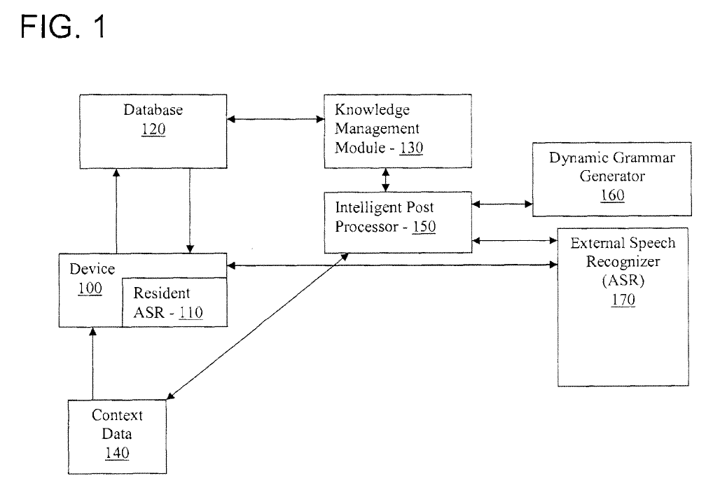

FIG. 1 is a representation of a high-level framework within which various embodiments of the present invention may be implemented. The framework shows a client device 100 that uses context data 140 and intelligence to record, for example, one's daily life events, and stores them in a database 120. The client device 100 includes a resident ASR in the arrangement of FIG. 1. A post processing module, comprising a knowledge management module 130 and an intelligent post processor 150, parses the sent media for post processing. The post processing module derives additional information from the media. This information can include, for example, information relating to segmenting through contextual cues, speech grammar, additional contextual data, further context data added through external services etc. The post processed media is stored in the database 120, along with contextual information that would be helpful during searching of that media at a later time.

Various embodiments of the present invention provide speech recognition services for searching previously stored media through use of one or more external speech recognizers, also referred to as external ASRs and shown at 170 in FIG. 1, as well as the resident ASR 110. Hot word recognition, where the resident ASR 110 and external ASR 170 listen for particular words in the user's speech is used. When these words are encountered, the resident ASR 110 and external ASR 170 inform the relevant application that a hot word within a specified grammar has been recognized by the system. These key words augment fine tuned search and semantic constructs that pertain to what the user actually meant. A dynamic grammar generator 160 can provide a set of “possible” key words as a grammar set, resulting in a higher rate of recognition than would otherwise be possible by simply relying on the resident ASR 110 and external ASR 170 examining the entire potential vocabulary set. For a first-level search of media, the client device 100 can use the services of the external ASR 170, in the form of a network-based ASR, with a large vocabulary capability that can detect words for providing a search within the database. The speech grammar for the first level search can comprise a large vocabulary set that is augmented by a smaller, higher priority vocabulary. This higher priority vocabulary can be derived based on user interaction patterns etc.

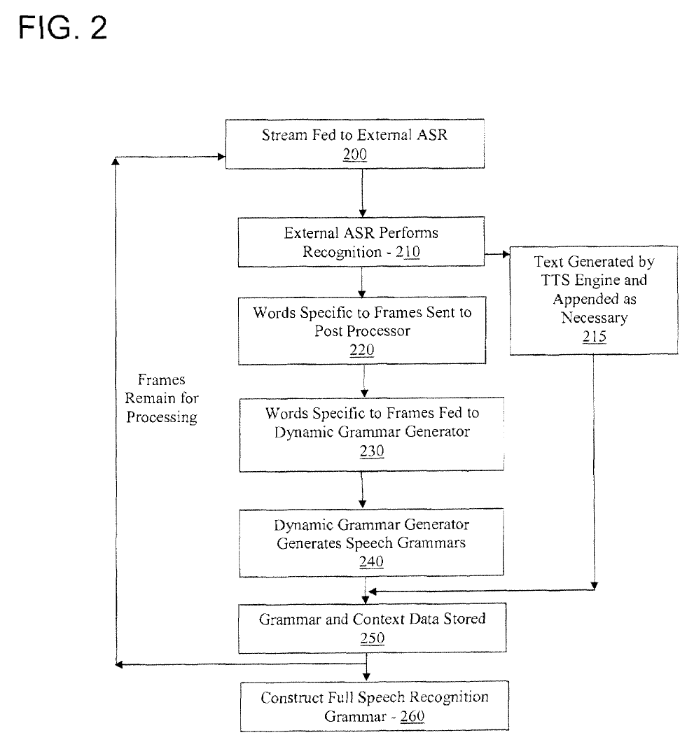

FIG. 2 is a depiction of how dynamic contextual grammar may be generated in accordance with various embodiments of the present invention. In this process, dynamic context-based grammar is generated for an audio stream during the post-processing period. This is accomplished via the post processor along with the external ASR 170. At 200, an audio stream is fed to the external ASR 170 for a specific number of frames. At 210, the external ASR 170 performs recognition of words that do not occur in common vocabulary that would and/or could be specific to those audio frames. In the case where the external ASR 170 encounters words that are not within its high-end vocabulary (such as names, etc.), the audio frame set can be sent to a Text-to-Speech (TTS) engine that generates text from the audio stream. The generated text can then be appended to the grammar set for that audio stream. This is represented at 215 in FIG. 2. Words that are specific to the frames are then sent back to the post processor at 220, where they are fed to the dynamic grammar generator 160 at 230. At 240, the dynamic grammar generator 160 proceeds to generate speech grammars in a predetermined format, for example, the speech recognition grammar format (SRGF), using the words that were fed to it. This grammar, along with other contextual information, forms the new set of context data for those frames of media. The media along, with the grammar and other context data, is then stored in the database 120 at 250. This process is repeated for the entire stream of media, and a full speech recognition grammar can be constructed at 260 by simply appending all of the grammar that was generated for each segment of the, or a recognized query generated by the external ASR 170, the entire media stream and the speech recognition grammar related to that stream is downloaded. This new grammar is added to a global small-vocabulary grammar that is present in the resident ASR 110. The words in the new grammar can act as hot-words for the resident ASR 110. These words act as cues for finer searching and navigation within the media. Because the grammar is suited for the downloaded media, usage of the external ASR 170 is avoided. This eliminates large vocabulary recognition, as well as unnecessary round trip time and delays while, at the same time, improving recognition accuracy. When new media is downloaded from the database 120 based on a new search, the old grammar that was valid for the previous media can be replaced by a new grammar that addresses the new media.

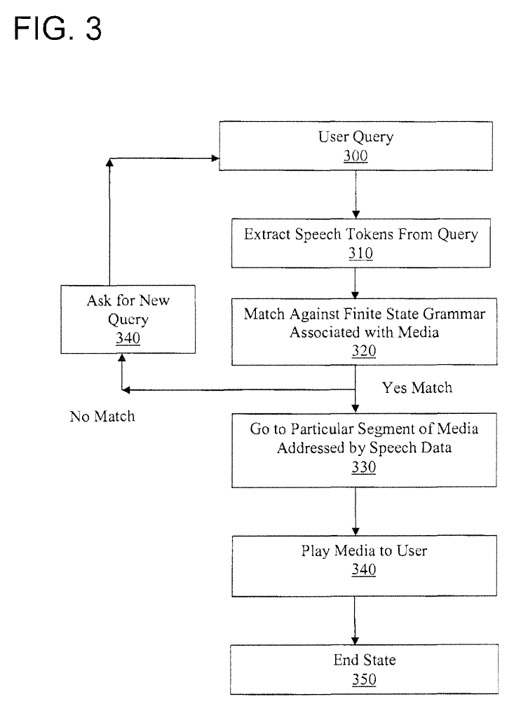

FIG. 3 is a flow chart showing a user interaction process, once a speech grammar has been extracted through post processing, according to various embodiments of the present invention. At 300 in FIG. 3, a user query occurs. At 310, speech tokens are extracted from the query. At 320, an attempt is made to match these tokens against finite state grammar that is associated with the media. If there is no match, then the system asks for a new query at 340 and processes 300-320 are repeated. If, on the other hand, there is a match, the system proceeds to the particular segment of media that is addressed by the speech query and was found to be a match at 330. This segment is played to the user at 340, and the end state is reached at 350.

An example implementation of the process depicted in FIG. 3 can comprise, for example, a situation where would be a user searches for meeting recordings a certain date. Once the relevant media has been downloaded, a user can search within the media by stating (in voice) “show me the part where (person's name) discusses (subject).” The application processing the media content can then go directly to the relevant portion of the media.

Another use case where dynamic grammar generation is helpful relates to the intelligent recording of media at the client side. In this environment, dynamically generated “hot words” within post-processed media can also act as subsequent identifiers to the client device for intelligent recording. The client device may want to record related media when and where it occurs. For this purpose, it would need identifiers that can link two media items together. The identifiers can comprise the “hot words” that were generated by a previous post-processed media item. Such hot words can be appended to a global grammar set that is present on the client device 100. The client device 100 can use these hot words (with its resident ASR 110) to intelligently detect events that would be relevant for recording. The client device 100 can then send the recorded media back to a server that keeps a transcript of previous hot words. The hot word sets can then be used to associate two event sets to each other. Additionally, certain distance metrics can be used between the hot word sets of different media to compute association relationship strengths. These association relationship strengths can later be used when a user looks for related events.

To generate better associations, the grammar sets that are used (along with other context information) can be used to make only intelligent recording decisions only. Once the media is recorded, it can be sent to the post processing server, where new grammar sets are extracted. However, these new grammar sets can also be compared with previous existing grammar sets for prior recordings, and associations can be created. Therefore, when a user downloads a media, these associations can be used to provide associated or otherwise similar events to the user at the same time based upon the downloaded media.

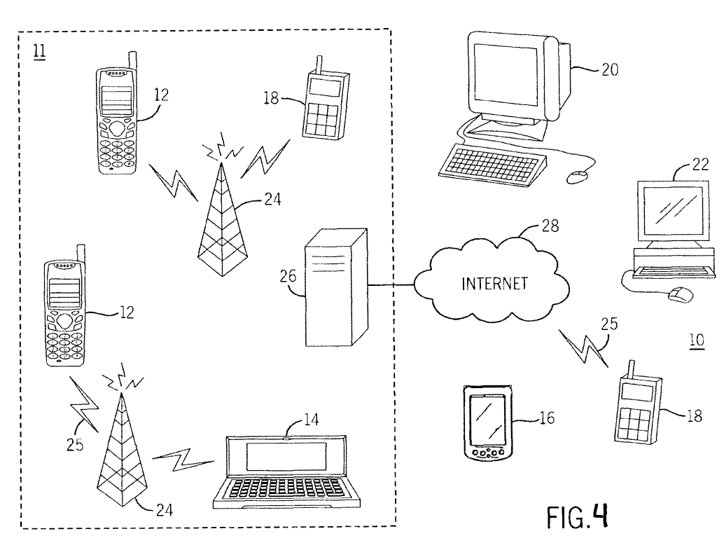

FIG. 4 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 4 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

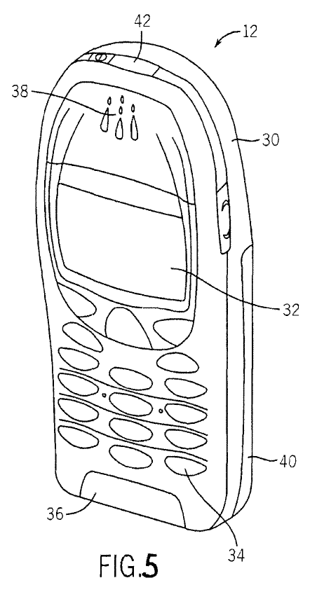

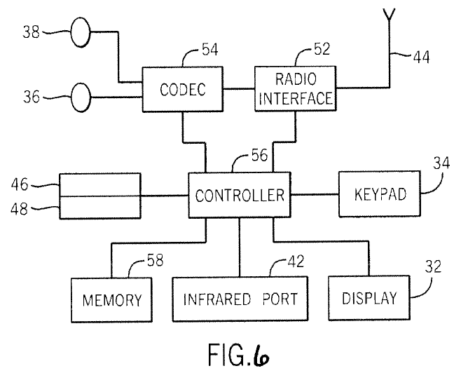

FIGS. 5 and 6 show one representative mobile telephone 12 within which the present invention may be implemented. It should be understood, however, that the present invention is not intended to be limited to one particular type of mobile telephone 12 or other electronic device. The mobile telephone 12 of FIGS. 5 and 6 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of generating a dynamic contextual speech recognition grammar, comprising:
for each of a plurality of groups of at least one frame of audio content, generating grammars and context data including:
providing the at least one frame of audio content to an automatic speech recognizer (ASR) for performing recognition of words that do not occur in common vocabulary and may be specific to the at least one frame;
receiving from the ASR words that are specific to the at least one frame at a post processor; and
having a dynamic grammar generator generate speech grammars using the words that are specific to the at least one frame, the words being provided from the post processor.

2. The method of claim 1, wherein the ASR is an external ASR.

3. The method of claim 1, wherein the external ASR is a network-based ASR.

4. The method of claim 1, wherein the speech grammars are generated in a speech recognition grammar format (SRGF).

5. The method of claim 1, further comprising storing the speech grammars and context data in a database.

6. The method of claim 5, wherein all of the generated speech grammars are appended to each other to create a full speech recognition grammar.

7. The method of claim 6, wherein the full speech recognition grammar is added to a global small-vocabulary grammar that is present in a resident ASR.

8. The method of claim 7, wherein words in the full speech recognition grammar are used by the resident ASR as hot words for searching and navigating within the media idem.

9. The method of claim 1, further comprising:
for each of the plurality of groups of at least one frame of audio content, using a Text-to-Speech (TTS) engine to generate text from the at least one frame of audio content for words that are not recognized by the ASR; and
appending the generated text to the generated speech grammars.

10. A computer program product, embodied in a computer-readable medium, comprising computer code for performing the processes of claim 1.

11. The computer program product of claim 10, further comprising computer code for storing the speech grammars and context data in a database.

12. The computer program product of claim 11, wherein all of the generated speech grammars are appended to each other to create a full speech recognition grammar.

13. An apparatus, comprising:
a processor; and
a memory unit communicatively coupled to the processor and comprising computer code for, for each of a plurality of groups of at least one frame of audio content, generating grammars and context data including:
computer code for providing the at least one frame of audio content to an automatic speech recognizer (ASR) for performing recognition of words that do not occur in common vocabulary and may be specific to the at least one frame;
computer code for receiving from the ASR words that are specific to the at least one frame at a post processor; and
computer code for having a dynamic grammar generator generate speech grammars using the words that are specific to the at least one frame, the words being provided from the post processor.

14. The apparatus of claim 13, wherein the ASR is an external ASR.

15. The apparatus of claim 13, wherein the external ASR is a network-based ASR.

16. The apparatus of claim 13, wherein the speech grammars are generated in a speech recognition grammar format (SRGF).

17. The apparatus of claim 13, wherein the memory unit further comprises storing the speech grammars and context data in a database.

18. The apparatus of claim 17, wherein all of the generated speech grammars are appended to each other to create a full speech recognition grammar.

19. The apparatus of claim 18, wherein the full speech recognition grammar is added to a global small-vocabulary grammar that is present in a resident ASR.

20. The apparatus of claim 19, wherein words in the full speech recognition grammar are used by the resident ASR as hot words for searching and navigating within the media idem.

21. The apparatus of claim 13, wherein the memory unit further comprises:
computer code for, for each of the plurality of groups of at least one frame of audio content, using a Text-to-Speech (TTS) engine to generate text from the at least one frame of audio content for words that are not recognized by the ASR; and
computer code for appending the generated text to the generated speech grammars.

22. A system, comprising:
a post processor configured to process a plurality of groups of at least one frame of audio content;
an external automatic speech recognizer (ASR) communicatively connected to the post processor and configured to perform recognition of words that do not occur in common vocabulary and may be specific to the at least one frame for each group;
a dynamic grammar generator communicatively connected to the post processor and configured to generate speech grammars using the words that are specific to the at least one frame, the words being provided from the external ASR via the post processor; and
a database communicatively configured to store the speech grammars generated by the dynamic grammar generator.

23. The system of claim 22, wherein the database is communicatively connected to a device including a resident ASR, and wherein words in the full speech recognition grammar are used by the resident ASR as hot words for searching and navigating within the audio content.

24. The system of claim 22, wherein the speech grammars are generated in a speech recognition grammar format (SRGF).

25. The system of claim 22, wherein all of the generated speech grammars are appended to each other to create a full speech recognition grammar.

26. The system of claim 25, wherein the full speech recognition grammar is added to a global small-vocabulary grammar that is present in a resident ASR of a device communicatively connected to the database.

27. A method of searching for a speech segment within a media item, comprising:
extracting at least one speech token from a received user query;
matching the at least one speech token against an extracted speech grammar associated with the media item; and
proceeding to a segment of the media item that matches the at least one speech token.

28. The method of claim 27, further comprising playing the segment of the media item to the user.

29. The method of claim 27, further comprising:
if the at least one speech token cannot be matched with a segment of the media item, requesting a new user query; and
continuing to request new user queries and extract speech tokens until a match is made with a segment of the media item.

30. A computer program product, embodied in a computer-readable medium, including computer code for performing the processes of claim 1.

31. An apparatus, comprising:
a processor; and
a memory unit communicatively connected to the processor and including:
computer code for extracting at least one speech token from a received user query;
computer code for matching the at least one speech token against an extracted speech grammar associated with a media item; and
computer code for proceeding to a segment of the media item that matches the at least one speech token.

32. The computer program product of claim 31, wherein the memory unit further comprises computer code for playing the segment of the media item to the user.

33. The method of claim 27, wherein the memory unit further comprises:
computer code for, if the at least one speech token cannot be matched with a segment of the media item, requesting a new user query; and
computer code for continuing to request new user queries and extract speech tokens until a match is made with a segment of the media item.

34. A system, comprising:
means for processing a plurality of groups of at least one frame of audio content;
means for performing recognition of words that do not occur in common vocabulary and may be specific to the at least one frame for each group;
means for generating speech grammars using the words that are specific to the at least one frame, the words being provided from the external ASR via the post processor; and
means for storing the speech grammars generated by the dynamic grammar generator.

35. The system of claim 34, wherein all of the generated speech grammars are appended to each other to create a full speech recognition grammar.
